(19) United States
(12) Patent Application Publication
(10) Pub. No.: US 2012/0152931 A1
(43) Pub. Date: Jun. 21, 2012

(54) ELECTRICAL HEATING DEVICE

(75) Inventors: Franz Bohlender, Kandel (DE); Klaus Beetz, Karlsruhe (DE)

(73) Assignee: Eberspacher catem GmbH & Co. KG, Herxheim (DE)

(21) Appl. No.: 13/327,872

(22) Filed: Dec. 16, 2011

(30) Foreign Application Priority Data
Dec. 20, 2010 (EP) 10015844.3

(51) Int. Cl. H05B 3/06

(52) U.S. Cl. 219/520

(57) ABSTRACT

An auxiliary electrical heating device for a motor vehicle includes a heating block that includes parallel layers of at least one heat emitting element and at least one heat generating element. The heating block is held in a housing having oppositely situated housing openings. In order to permit the electrical heating device to be operated safely even at high operating voltages, a contact protection of an insulating material covers the respective housing openings.

### BACKGROUND OF THE INVENTION

1. Field of the Invention

The present invention relates to an electrical heating device, in particular to a heating device as auxiliary heating for a motor vehicle, with a heating block that has parallel layers of at least one heat emitting and one heat generating element, which layers are enclosed by a housing that has oppositely situated housing openings formed therein.

2. Description of the Related Art

An electrical heating device of this nature is known for example from EP 1 768 459 A1 which originates from the applicant. A generic electrical heating device of the above-mentioned type normally has a heat generating element with at least one PTC element, on the oppositely situated lateral faces of which electrically conducting sheet metal bands abut, through which the PTC element is supplied with electrical current. This electrical supply is normally provided at 12 volts. This operating voltage is harmless, so that normally no special measures need to be taken to prevent unintentional contact with the heating block. Normally, heat emitting elements, which are supplied electrically with the same polarity as the sheet metal bands, are situated externally on oppositely situated sides on the heat generating elements. In this respect the heat emitting elements, which are irradiated by the medium to be heated and which lie exposed in the frame openings, carry electrical current.

From the previously mentioned state of the art it is known how to provide an insulating layer between the heat emitting elements and the sheet metal bands, in particular for higher operating voltages. Accordingly the strip conductors to the PTC element or elements and the heat emitting elements, i.e. the radiator layers of the heating block, are electrically insulated. This electrical insulation however also causes a certain thermal insulation by means of which the efficiency of the PTC elements is impaired. These PTC elements have self-regulating properties so that operation of the PTC elements with good efficiency gives the most possible undisturbed dissipation of the heat generated by the PTC elements.

### SUMMARY OF THE INVENTION

The object of the present invention is to provide an electrical heating device of the type mentioned in the introduction, which can be operated safely even at high operating voltages.

To resolve this problem with the present invention, the previously mentioned electrical heating device is further formed by at least one contact protection of an insulating material covering the respective housing opening. According to the present invention a housing opening, in particular the front housing opening in the direction of flow, i.e. the housing opening through which the air flowing through the heating device initially flows, is provided with contact protection. Preferably, both of the mutually oppositely situated housing openings which normally enclose the planar heating block are covered by contact protection. The contact protection covers in particular the current-carrying parts of the heating block. The contact protection is selected to be so fine meshed that a user cannot touch the heating block by inserting his fingers through the frame opening. Preferably, the contact protection is equipped such that also tools normally used for repair purposes cannot access the heating block through the frame opening. A relatively finely meshed plastic mesh is particularly considered here. The plastic mesh should be formed from a relatively temperature-resistant plastic, in particular nylon or Teflon. The plastic mesh can here also be considered to be formed in a grid shape. In this respect finely meshed means preferably that the mesh size is specified between 0.7 and 1.0 mm, preferably between 0.8 and 0.9 mm. The objective should be the prevention of the insertion of a test wire with a diameter of 1.0 mm with a force of 1 N into the heating block, i.e. through the contact protection. With regard to the best possible flow through the contact protection the open area for flow through the contact protection should be selected with about 75 to 90%, preferably with 85 and 90%.

With the present invention safe contact protection is provided so that it is no longer necessary to provide an insulating layer between the heat generating elements and the heat emitting elements. The efficiency of the heating device according to the invention is therefore improved compared to the prior art of EP 1 768 459 A1, particularly if a multi-layered redundant insulating layer is formed which has relatively poor thermal conductivity.

From EP 1 621 378 A1 an electrical heating device of the generic type is known in which oppositely situated housing openings are covered with flow-resistant grids. The flow-resistant grids however are used to provide a suitable adjustment of a flow resistance through the housing at those points where elements of the heating block are missing. The suggestion according to the invention differs from this in that the contact protection is positioned in the direction of flow directly before or after the active elements of the heating block, i.e. after the at least one heat emitting element and/or the at least one heat generating element. A corresponding situation applies to EP 1 173 340 A1, which discloses at least one placeholder element in the housing which is located adjacent to an element of the heating block.

With the electrical heating device according to the invention the heating block is circumferentially enclosed by the housing, normally formed from insulating material, in particular plastic, whereas the mutually oppositely situated housing openings left free by the housing are covered by the contact protection, particularly by the plastic grid, such that the medium to be heated, normally air, can pass through the contact protection to the heating block, in particular to the current-carrying components of the heating block situated behind the contact protection in the flow direction, but not however body parts of an installer or service person or a tool used by these persons nor a foreign body which has entered the air passage or optionally has been brought in with the air flow.

According to a further development of the present invention in which the plastic mesh is mounted on a strut arrangement, the struts of which span the respective housing openings, the plastic mesh is prevented from abutting the surface of the heating block. The strut arrangement can be formed from one or more mutually parallel struts or also a grid arrangement. The individual struts or grid bars of the strut arrangement are preferably formed so rigidly that with normal loads no significant deflection occurs such that the plastic mesh can abut the surface of the heating block exposed towards the housing opening.

With regard to an economical manufacture, according to a further development of the present invention it is suggested that the plastic mesh is joined to the struts of the strut arrangement by overmoulding of the plastic mesh with a plastic component forming the strut arrangement. Consequently, during the manufacture of the electrical heating device the plastic mesh is placed into an injection mould, which comprises a mould cavity for moulding the strut arrangement. The mould cavity is here preferably formed such that the plastic component for forming the strut arrangement is not only formed on one side of the plastic mesh, but also on the opposite side so that after overmoulding on both sides of the plastic mesh, the plastic mesh is sealed in as a rigid plastic component. The strut or grid arrangement is here preferably formed such that the struts which in each case extend parallel to the heating block layers are located at the same height as the heat generating elements so that the medium to be heated can flow over the heat emitting elements without hindrance.

According to a preferred further development at least one spacing element is provided between the heating block and the contact protection. This prevents direct contact with the heating block elements occurring through the contact protection even with a certain deflection of the contact protection and optionally also of the strut arrangement due to a conceivable, externally acting application of pressure. The spacing element or elements are selected such that normally a spacing between the contact protection and heating block of between 4 and 8 mm is provided. With conceivable deflections of the contact protection the spacing between the heating block and the contact protection due to suitable dimensioning of the spacing element or elements should be at least 2 mm. The spacing elements can be provided on both sides of the heating block between it and the frame openings covered by the contact protection.

According to a preferred further development the spacing element is formed by a spacing support protruding over the struts of the strut arrangement on the inside and/or by a spacing web, which protrudes over a positional frame of the heat emitting element, accommodating at least one PTC element, and preferably formed as one part with it.

In the second case the heat generating element is formed in a manner known per se by at least one PTC element, which is provided between mutually parallel sheet metal bands and which is accommodated in a positional frame of an insulating material. The positional frame normally has a plurality of receptacle openings for accommodating one or more PTC elements. Normally, the positional frame has a thickness which is less than the thickness of the PTC elements. According to the further development, the positional frame however also forms the spacing element, which protrudes over the essentially flat heating block and maintains the spacing of the contact protection, particularly the plastic mesh, with respect to the surface of the heating block. For this purpose the positional frame is normally extended out of the plane of the heating block and protrudes beyond it.

In the other design case the at least one strut of a strut arrangement penetrating the housing opening is formed as a spacing element. In a manner known per se the struts can extend parallel to the layers of the heat emitting elements and in front of them. Also, cross struts extending at right angles to these struts can be provided with spacing webs. The spacing support can here interact with the spacing web, which is formed by the positional frame, to realize the required spacing between the contact protection and the heating block elements. Thus, the spacing supports and the spacing webs can in each case be formed continuously in the longitudinal direction with the struts or positional frame. In each case, at the intersection of the spacing support and spacing web at least one spacing support or spacing web can have a recess accommodating the other so that there is a certain linking of the two elements.

According to a preferred further development of the present invention, the strut arrangement is clipped to the housing together with the plastic mesh. This embodiment offers the possibility of retrofitting the contact protection according to the invention to installed electrical heating devices. The clipping is normally realized by latching elements which are formed during injection moulding of the strut arrangement.

With an alternative embodiment the housing comprises a housing upper part and a housing lower part, whereby each of the housing parts leaves one of the housing openings free. The housing parts are formed from plastic and circumferentially enclose the housing block. They normally have the strut arrangement so that the plastic mesh is directly joined to the associated housing part by overmoulding with the plastic material forming the housing parts.

According to a further preferred embodiment of the present invention, a creep path of at least 5 mm is in each case formed between the current-carrying components of the heating block and the contact protection. On one hand the spacing elements contribute to this creep path and namely also when they just provide spacing between the heating block and the inner side of the contact protection which is less than the above measure for the creep path. In this case an appropriate creep path is realized by the geometric embodiment of the spacing element or elements. In particular, protrusions extending parallel to the plane of the heating block and which increase the creep path are formed on the spacing element or elements.

### BRIEF DESCRIPTION OF THE DRAWINGS

Further details and advantages of the invention are given in the following description of embodiments in conjunction with the drawing. This shows the following:

FIG. 1 a perspective side view of a first embodiment before the contact protection is fitted;

FIG. 2 a perspective plan view onto the contact protection according to FIG. 1;

FIG. 3 a perspective plan view of a second embodiment of the present invention;

FIG. 4 a perspective interior view of a housing part of the second embodiment illustrated in FIG. 3;

FIG. 5 a cross-sectional view of the second embodiment illustrated in FIGS. 3 and 4; and

FIG. 6 a perspective interior view according to FIG. 4 of a housing of a third embodiment.

### DETAILED DESCRIPTION OF THE PREFERRED EMBODIMENT

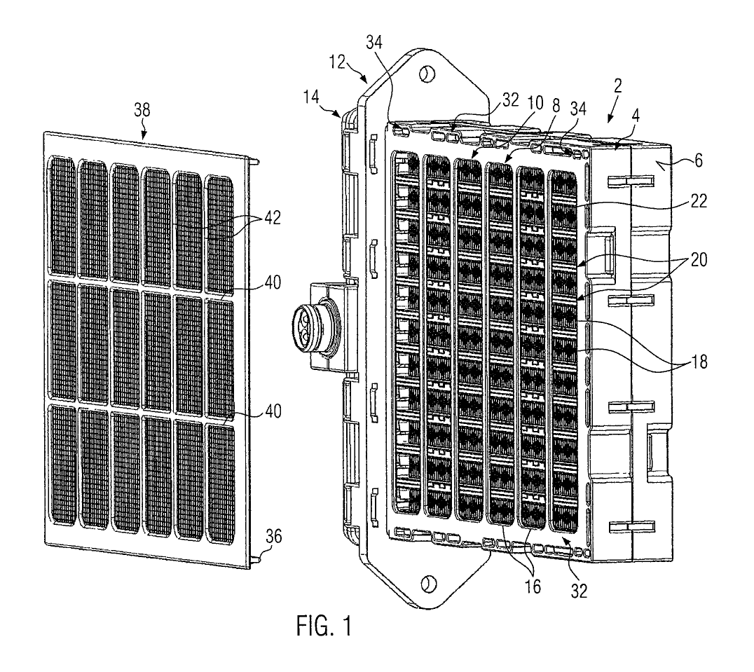

FIG. 1 illustrates an electrical heating device as auxiliary heating for a motor vehicle with a housing 2 comprising two identically formed housing parts 4, 6, which are joined by clipping, thus enclosing a heating block 8. The housing parts 4, 6 each have a housing opening 10 which is open to the heating block 8 and are joined on their connecting side to a flange 12 which provides access to and holds the electrical plug contacts for the connection of the heating block 8 as well as a controller enclosed by a control housing 14.

FIG. 1 shows the embodiment from the flow inlet side. Here, the housing opening 10 of the housing part 4 is penetrated by five cross struts 16. The longitudinal spars 16 extend at right angles to the parallel layers of the heating block 8. These layers are formed by heat emitting elements in the form of radiator elements 18 and heat generating elements 20 accommodated between them.

As emerges particularly from FIG. 5, the heat generating elements 20 each consist of a positional frame 22 of an electrically insulating material which has a receptacle opening 24 for the accommodation of a PTC element 26 in each case. The positional frames 22 in turn accommodate electrically conducting sheet metal bands 28 which abut on oppositely situated sides of the PTC element 16 and supply them with electrical current. In the embodiment illustrated in FIG. 5 insulating layers 30 are provided in each case on the outer side of single sheet metal bands 28, which insulate the sheet metal bands 28, which are supplied with electrical current of different polarity, with respect to the metallic radiator elements 18, so that individual heat generating elements 20 are electrically delimited from one another and can be specifically controlled. Within the heating block 8 different potentials are prevented from being directly opposite one another. Consequently, it is possible for example to operate two heating stages of the heating block using one ground connection.

Mutually oppositely situated longitudinal spars 32 of the frame-shaped housing 2 have latch openings 34 for the accommodation of latch protrusions 36 of a cover 38 which forms contact protection. This cover 38 consists of an injection moulded covering frame 44 through which frame longitudinal and cross struts 40, 42 pass. The cover 38 also comprises a plastic mesh 46, which is joined on both sides to the plastic material forming the struts 40, 42 and the covering frame 44 by means of overmoulding. Accordingly, the struts 40, 42 and the covering frame 44 are formed in the flow direction on both sides of the plastic mesh 46.

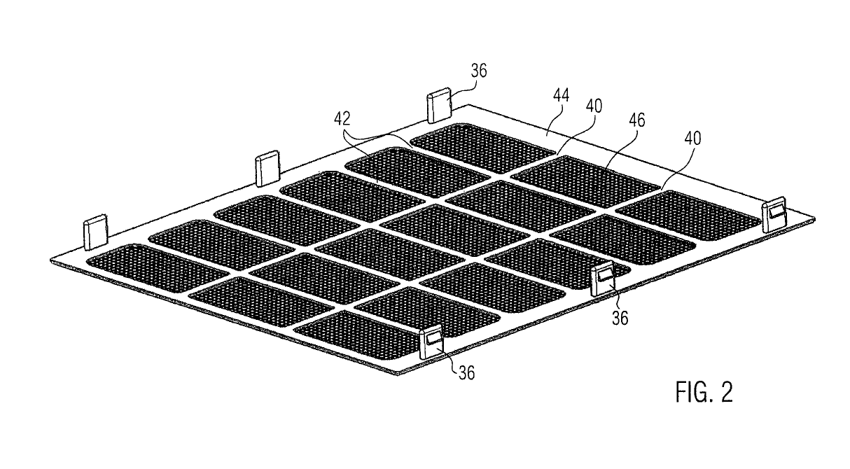

The cover 38 illustrated in FIGS. 1 and 2 can be detachably joined to the housing 2. For this purpose the latch protrusions 36 are introduced into the assigned latch openings 34.

Latch lugs formed on the latch protrusions 36 latch with respect to the housing 2 so that the cover 38 is retained captively on the housing 2.

In the embodiment illustrated in FIGS. 1 and 2 the plastic mesh 46 has a mesh size such that a piece of wire with a nominal diameter of 1 mm cannot pass through the plastic mesh 46 to the elements 18, 20 of the heating block 8.

The frame cross struts 42 are aligned with the cross struts 16 of the housing part 4. Due to the accumulated thickness of the cross struts 16 and the cover 18, in particular in the region of the frame cross struts 42, there is a free distance of about 6 mm between the surface of the heating block 8 and the plastic mesh 46. Due to the frame longitudinal struts 40 the plastic mesh 46 is additionally stiffened, so that a pressure force acting on the plastic mesh 46 does not lead to it being pressed down to the level of the heating block 8.

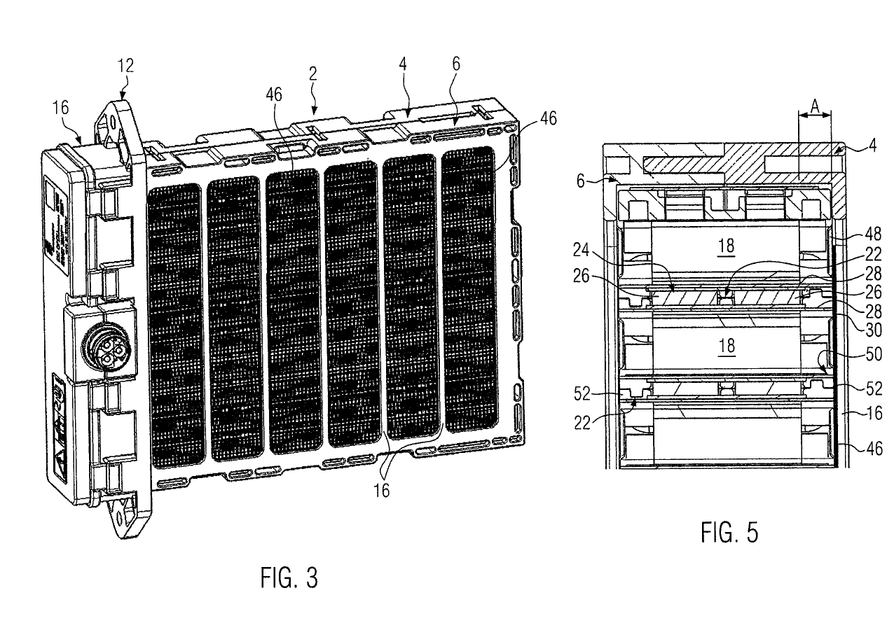

A further embodiment is given in FIGS. 3 to 5. The same components are given the same reference numerals compared to the previously discussed embodiment. Whereas the previous embodiment illustrated with reference to FIGS. 1 and 2 is particularly suitable for retrofitting existing electrical heating devices, the embodiment given in FIGS. 3 to 5 is produced from the beginning as an electrical heating device according to the invention. Consequently, the plastic mesh 46 is formed as part of the housing part 4 or 6.

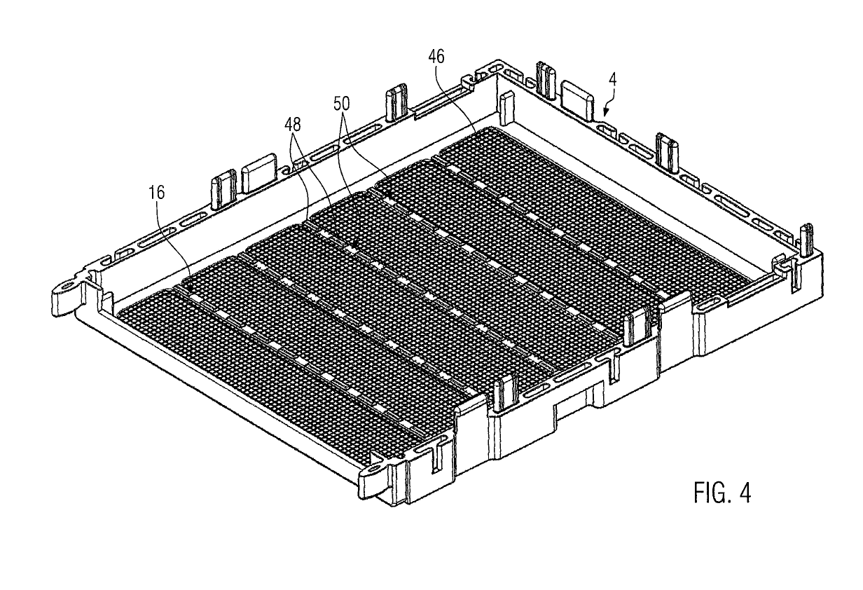

As shown particularly in FIG. 4, also with the second embodiment the plastic mesh 46 is joined by overmoulding to the material forming the housing part 4. The material forming the cross struts 16 of the housing part 4 is here located on the two sides of the plastic mesh 46 and protrudes over it. In addition, on the inner side cams 48 are formed protruding over the cross struts 16, delimiting a free space 50, the height of which (extending in a direction transverse to the layers of the layered heating block) corresponds approximately to the thickness of the heat generating elements 20, so that they can be accommodated between the cams 48 (cf. FIG. 5). Due to this embodiment the heat generating elements 20 are fixed in their plane. The cams 48 provide an adequate distance between the plastic mesh 46 and the radiator element or elements 18, even with a certain deflection of the cross struts 16.

Although the second embodiment according to FIGS. 3 to 5 only has cross struts 16, it is pointed out here that the relevant housing parts 4, 6 can have not only a strut arrangement with cross struts 16, but also such an arrangement as has been described above for the cover 38 and which has cross struts and longitudinal struts. A strut arrangement of this nature leads to a particular stiffening of the housing opening 10 and largely prevents a deflection of the contact protection in the direction of the heating block 8.

As particularly emerges from FIG. 5, with the embodiment according to FIGS. 3 to 5 the positional frames 22 are extended beyond the heating block 8, i.e. in the direction of flow. The positional frames 22 accordingly form spacing webs 52 which protrude on both sides of the heating block 8. These spacing webs 52 interact with the two housing parts 4, 6 and keep the cross struts 16 spaced to the heating block 8. Due to the plurality of supporting points along the cross struts there is no concern that they will deflect substantially in the direction of the heating block 8, for example in the case of a pressure force acting on the housing part 4 externally. As emerges from FIG. 5, here it should be noted that only the housing part 4 is provided with plastic mesh 46, whereas the housing part 6 with otherwise an identical embodiment has no corresponding plastic mesh 46. The two housing parts 4, 6 can therefore be formed in injection moulding tools of identical geometry with the difference that in one injection moulding tool for the manufacture of the housing part 4 the plastic mesh 46 is inserted as an inserted part before the moulding of the plastic components. The dimension of the spacing webs 52 at right angles to the plane accommodating the heating block 8 is selected such that a spacing A of between 4 and 8 mm is produced between the surface of the heating block 8 and the contact protection 46.

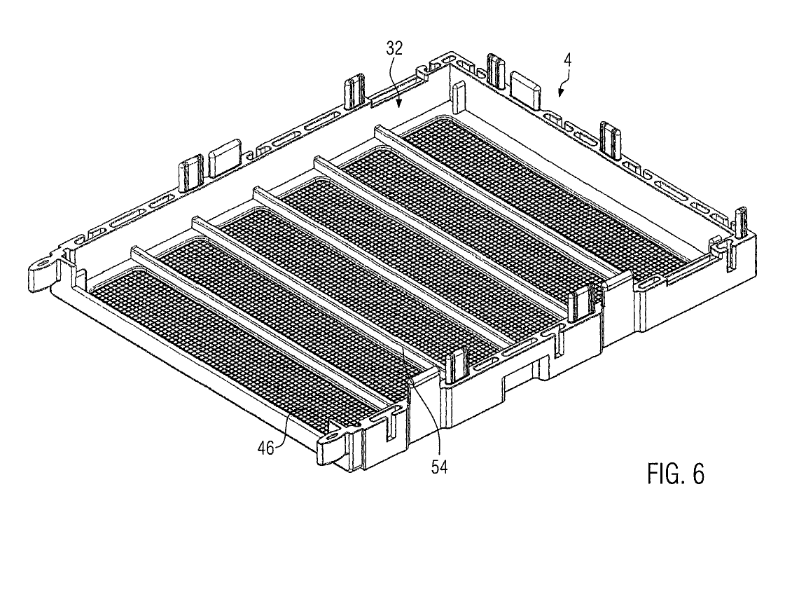

FIG. 6 illustrates a housing part 4 of a further embodiment, which is formed identically to the embodiment previously described with the difference that parallel to the cross struts 16 on the inner side of the housing part 4 there are spacing supports 54, which extend between the two longitudinal spars 32 continuously at a uniform height and which protrude over the struts 16, 40, 42 on the inside of the housing 2. The height of the spacing supports 54 is selected such that the contact protection 46 is maintained at a predetermined distance from the heating block 8. The contact protection 46 is supported via the spacing support 54 in particular with the face sides of the positional frames 22.

It is pointed out that the spacing supports 54 can also be provided in combination with the spacing webs 52 of the positional frames 22 to realize a desired distance between the plastic mesh 46 and the heating block 8 due to the spacing webs 52 and spacing supports 54 essentially crossing at right angles. Here the face sides of the spacing webs 52 and/or the spacing supports 54 can be formed like cams with free spaces between, as has been described above with reference to the second embodiment.

What is claimed is:

1. An auxiliary electrical heating device for a motor vehicle comprising:
a heating block comprising parallel layers of at least one heat emitting element and at least one heat generating element; and
a housing that holds the heating block, the housing having housing openings formed therein, wherein the electrical heating device comprises a contact protection of an insulating material which covers at least one of the housing openings and comprises a finely meshed plastic mesh.

2. An electrical heating device according to claim 1, wherein the plastic mesh is fastened to a strut arrangement, struts of which span the respective housing openings.

3. An electrical heating device according to claim 2, wherein the plastic mesh is joined to the strut arrangement by overmoulding of the plastic mesh to a plastic component of the strut arrangement.

4. An electrical heating device according to claim 1, further comprising at least one spacing element provided between the heating block and the contact protection.

5. An electrical heating device according to claim 4, wherein the spacing element is formed by at least one of 1) a spacing support protruding over the struts of the strut arrangement on the inside of the housing and 2) by a supporting web which protrudes over a positional frame of the heat generating element that accommodates at least one PTC element of the heat generating element

6. An electrical heating device according to claim 2, wherein the strut arrangement and the plastic mesh are clipped onto the housing.

7. An electrical heating device according to claim 1, wherein the housing has a first housing upper part and a second housing lower part, each of which has one of the housing openings free, and wherein the plastic mesh is joined to at least one of the assigned housing parts via overmoulding.

8. An electrical heating device according to claim 4, wherein a creep path of at least 5 mm is formed between current-carrying components of the heating block and the contact protection.

9. An auxiliary electrical heating device for a motor vehicle, comprising:
a heating block comprising parallel layers of at least one heat emitting element and at least one heat generating element; and
a housing that holds the heating block, the housing having oppositely situated housing openings, wherein the electrical heating device comprises a contact protection of an insulating material, wherein the contact portion covers at least one of the housing openings, and wherein a creep path of at least 5 mm is formed between the current-carrying components of the heating block and the contact protection.

10. An electrical heating device according to claim 9, wherein the contact protection comprises a plastic mesh.

11. An electrical heating device according to claim 9, further comprising at least one spacing element provided between the heating block and the contact protection.

12. An electrical heating device according to claim 10, wherein the plastic mesh is fastened to a strut arrangement, the struts of which span the respective housing openings.

13. An electrical heating device according to claim 12, wherein the plastic mesh is joined to the struts of the strut arrangement by overmoulding of the plastic mesh onto a plastic component of the strut arrangement.

14. An electrical heating device according to claim 12, wherein the strut arrangement and the plastic mesh are clipped onto the housing.

15. An electrical heating device according to claim 13, wherein the housing has a first housing upper part and a second housing lower part, each of which has one of the housing openings free, and wherein the plastic mesh is joined to the assigned housing part via of overmoulding.

16. An auxiliary electrical heating device for a motor vehicle, comprising:
a heating block comprising parallel layers of at least one heat emitting element and at least one heat generating element;
a housing that holds the heating block and that has oppositely situated housing openings, the housing having a strut arrangement having struts that span the respective housing openings; and
a finely meshed, insulating plastic mesh covering at least one of the housing openings, wherein the mesh is fixed on the strut arrangement and is joined to a plastic component of the strut arrangement by overmoulding.

17. An electrical heating device according to claim 16, further comprising at least one spacing element provided between the heating block and the plastic mesh.

18. An electrical heating device according to claim 17, wherein the spacing element is formed by at least one of 1) a spacing support protruding over the struts of the strut arrangement on the inside of the housing and 2) by a supporting web which protrudes over a positional frame of the heat generating element, the positional frame accommodating at least one PTC element of the heat generating element.

19. An electrical heating device according to claim 16, wherein the strut arrangement and the plastic mesh are clipped onto the housing as a unit.

20. An electrical heating device according to claim 16, wherein the housing has a housing upper part and a housing lower part, each of which has one of the housing openings located therein, and wherein the plastic mesh is joined to at least one of the housing parts by overmoulding.

21. An electrical heating device according to claim 16, wherein a creep path of at least 5 mm is formed between the current-carrying components of the heating block and the plastic mesh.
